(19) United States
(12) Patent Application Publication
(10) Pub. No.: US 2026/0167297 A1
(43) Pub. Date: Jun. 18, 2026

(54) Method for Operating a Pedal-Driven Vehicle and a Pedal-Driven Vehicle

(71) Applicant: Robert Bosch GmbH, Stuttgart (DE)

(72) Inventors: Daniel Gronbach, Stuttgart (DE); Joseph Reck, Weil Im Schoenbuch (DE); Juergen Stegmaier, Wannweil (DE); Marcus Boege, Rottenburg Am Neckar (DE); Matthias Weinmann, Balingen (DE)

(21) Appl. No.: 19/414,999

(22) Filed: Dec. 10, 2025

(30) Foreign Application Priority Data
Dec. 13, 2024 (DE) 10 2024 211 918.0

(51) Int. Cl. B62M 6/45

(52) U.S. Cl. CPC B62M 6/45

(57) ABSTRACT

A method for operating a pedal-driven vehicle is disclosed. The pedal-driven vehicle includes a drive for providing a drive torque for propelling the vehicle, a control unit, a detection unit, and a gearshift. The method includes (i) providing shift information for a planned shift operation, the shift information comprising a start time of the shift operation and an end time of the planned shift operation, (ii) determining a target torque curve for the drive torque as a function of the shift information, wherein the target torque curve comprises a first upper holding phase, a reduction phase, a lower holding phase, an increase phase, and a second upper holding phase, (iii) controlling the drive such that the time curve of the drive torque corresponds to or substantially corresponds to the target torque curve, (iv) performing the planned shift operation and detecting a completion of the shift operation at a completion time, wherein the completion time is before the end time point, and (v) adjusting the target torque curve as a function of the completion time.

This application claims priority under 35 U.S.C. § 119 to patent application no. DE 10 2024 211 918.0, filed on Dec. 13, 2024 in Germany, the disclosure of which is incorporated herein by reference in its entirety.

### BACKGROUND

Pedal-driven vehicles, in particular electric bicycles, may be provided with an additional electric drive, which is intended to assist the driver in pedaling and thus to simplify the propulsion of the vehicle for the driver.

If gear changes are performed on the pedal-driven vehicle to alter a transmission ratio in a drive train of the pedal-driven vehicle, a drive torque provided by the electric drive may have negative influences on components of the gear shift used for the gear change.

For example, for derailleur gears, it is necessary to shift the chain to another sprocket during a gear shift. In the course of this shift, the chain can be greatly accelerated by the electric drive due to a temporary lack of sprocket contact and the resulting freedom from the load of the drive. If the contact between the sprocket and the chain is restored subsequently, this will result in a jerky braking of the chain. Such a shift operation may result in damage to the components involved, and further restricts the comfort of use of the pedal-driven vehicle, as such a shift operation is perceived by a driver to be jerky.

### SUMMARY

The present disclosure relates to a method for operating a pedal-driven vehicle, a pedal-driven vehicle, a computer program product, a computer-readable medium, and a data carrier signal. Further features and details of the disclosure will emerge from the description and the drawings. Features and details described in connection with the method according to the disclosure naturally also apply in connection with the pedal-driven vehicle according to the disclosure and/or in connection with the computer program product according to the disclosure and/or in connection with the computer-readable storage medium according to the disclosure and/or in connection with the data carrier signal according to the disclosure, and vice versa, so that there is or can always be mutual reference with regard to the disclosure of the individual aspects of the disclosure.

The disclosure presented is particularly intended to provide improved operation of a gear shift of a pedal-driven vehicle with respect to improved comfort of use of the pedal-driven vehicle and/or increased service life of the components involved.

According to a first aspect, the present disclosure relates to a method for operating a pedal-driven vehicle, comprising at least one drive for providing drive torque for propelling the vehicle, at least one control unit, at least one detection unit, and at least one gearshift, the method comprising:
providing shift information for a planned shift operation, the shift information comprising a start time of the shift operation and an end time of the planned shift operation, in particular by the gearshift,
determining an, in particular temporal, target torque curve for the drive torque as a function of the shift information, in particular by the control unit, wherein the target torque curve comprises a first upper holding phase, a reduction phase, a lower holding phase, an increase phase and a second upper holding phase,
controlling the drive such that the time curve of the drive torque corresponds to or substantially corresponds to the target torque curve, in particular by the control unit,
performing the planned shift operation and detecting a completion of the shift operation at a completion time, wherein the completion time is before the end time, in particular by the detection unit and/or the control unit, and
adjusting the target torque curve as a function of the completion time, in particular by the control unit.

It may preferably be provided that the stated method steps are carried out in the specified order. Additionally or alternatively, it is contemplated that at least individual method steps will be performed recurrently, in particular in a loop and/or, at least in part, simultaneously. Additionally or alternatively, the method can be configured as a computer-implemented method.

In other words, a method of operating a pedal-driven vehicle is proposed, wherein the pedal-driven vehicle comprises at least one drive for providing a drive torque for propelling the vehicle. In particular, the drive may be configured to assist a rider during propulsion of the pedal-driven vehicle. Furthermore, the pedal-driven vehicle comprises at least one control unit, at least one detection unit, and at least one gearshift.

It is further provided that, in particular by way of the gear shift, shift information is provided for a planned shift operation. The shift information comprises a start time as well as an end time.

In the present case, the start time is to be understood as the time at which the planned shift operation is initiated by the gearshift. If the gearshift is configured as a derailleur gear, this may be, for example, the time at which a shifter of the gearshift is moved to shift the chain from one pinion to another pinion. The timing of the movement of the shifter does not necessarily indicate the timing at which the chain is moving. In particular, the movement of the chain may be delayed at the start time or the time of movement of the shifter, which will be discussed below.

In the present case, the end time is to be understood as the time at which the planned shift operation is expected to be completed by the gearshift. The time period between the start and end times thus denotes the duration of the planned shift operation. The duration of a shift operation may be influenced by various factors. For example, it is relevant whether a gear change to a higher or lower gear is carried out, i.e., using the example of a derailleur gear, the chain is shifted from a smaller to a larger pinion (change to a lower gear) or from a larger to a smaller pinion (change to a higher gear). Also, the use and number of possible climbing aids as well as their current circumferential position with respect to a revolution of the respective pinion will affect the duration of a shift operation. Preferably, the end time may be determined as a maximum end time, i.e., a time at which the shift operation will be definitively completed.

It is further provided that a target torque curve, in particular by the control unit, is determined as a function of the shift information, in particular as a function of the start time and the end time. The target torque curve is to be understood as a torque curve over time. Preferably, the target torque curve comprises a first upper holding phase, a reduction phase, a lower holding phase, an increase phase, and a second upper holding phase.

The first upper holding phase is to be understood as a phase in which the drive torque provided by the drive is kept constant or substantially constant. The first upper holding phase thus denotes a time period in which a drive-side torque reduction is not yet required. The torque provided in the first upper holding phase may thus be selected as a torque currently provided by the drive.

The reduction phase is to be understood as a phase in which the drive torque provided by the drive is reduced to a lower value than the upper holding phase. The reduction of the drive torque in the reduction phase can preferably occur linearly or substantially linearly and/or continuously, in particular not abruptly. In particular, the reduction may be made using a predetermined reduction gradient. The specified reduction gradient can in particular be selected such that a driving sensation that is comfortable for the driver is achieved despite a reduction in the driving torque. In particular, the sensation of a jerky reduction of the drive torque can thus be avoided.

The lower holding phase is further to be understood as a phase in which the drive torque provided by the drive is kept constant or substantially constant at a value reduced from the upper holding phase. By reducing the drive torque in the reduction phase or lower holding phase, the gearshift or the drive train of the pedal-driven vehicle can be relieved and the mechanical load on the components involved in performing the shift operation can be reduced. The torque provided in the lower holding phase may in particular be directed to avoiding mechanical damage to the gearshift or other components when performing a shift operation.

The increase phase is to be understood as a phase in which the drive torque provided by the drive is again increased, in particular from the value present in the lower holding phase. Preferably, the drive torque may be increased to the torque in the first upper holding phase. The increase of the drive torque in the increase phase can preferably occur linearly or substantially linearly and/or continuously, in particular not abruptly. In particular, the increase may be made using a predetermined increase gradient. The specified increase gradient can in particular be selected such that a driving sensation that is comfortable for the driver is achieved despite an increase in the driving torque. In particular, the sensation of a jerky increase of the drive torque can thus be avoided.

Preferably, the increase gradient and the reduction gradient may be identical or substantially identical in amount thereof.

Furthermore, the second upper holding phase is to be understood as a phase in which the drive torque, in particular currently, provided by the drive, is kept constant or substantially constant. In so doing, preferably the drive torque provided in the second upper holding phase may correspond or substantially correspond to that of the first upper holding phase.

It may preferably be provided that the phases mentioned are to be run or arranged in the order mentioned. In particular, the reduction phase may immediately follow directly after the upper holding phase and/or the lower holding phase may follow the reduction phase and/or the increase phase may follow the lower holding phase and/or the second upper holding phase may follow the increase phase. Preferably, the drive torque should remain continuous or not jump abruptly when transitioning between two phases.

According to the disclosure, it is further provided that the drive of the pedal-driven vehicle, in particular by the control unit, is controlled such that the drive torque provided by the drive corresponds or substantially corresponds to the target torque curve. In other words, the drive is controlled such that the drive torque provided by the drive follows the target torque curve.

The planned shift operation is also carried out, in particular by the gearshift, as well as a detection of a completion of the, in particular planned, shift operation at a completion time. The completion time of the gear change is before the end time provided as part of the shift information. It is further provided that the target torque curve is adjusted as a function of the completion time.

In the context of the disclosure, it was found that the end time that can be provided by a gearshift must be determined conservatively due to numerous influencing factors for the duration of a shift operation. Only in this way can it be ensured that a sufficiently long reduction of the drive torque is carried out and the shift operation can be reliably implemented without mechanical damage to the components involved. Due to this conservative estimate, however, the shift operation is already complete before the originally assumed end time. If the target torque curve is left unchanged in this case, this leads to an unnecessarily long suspension of the assistance for the rider by the drive. This is avoided by adjusting the target torque curve as a function of the completion time. In this respect, the present disclosure makes it possible, on the one hand, to protect the mechanical components involved in a shift operation, such as the chain or the pinion, from mechanical damage and, on the other hand, to ensure as high an availability of the drive as possible to assist the driver.

The start time can be provided in a simplified manner, in particular in the case of automatic gearshifts, since a driver cannot exert any direct influence and the shift time is generally known in advance. When determining the start time, for example, the curve of a driver torque can also be considered, such that the shift operation is performed at a dead center of the driver torque, i.e., a time at which the driver torque is as low as possible.

For manual gearshifts, the start time may be when a user action is detected on a user interface of the gearshift, particularly a shift lever.

The end time can be considered, in particular by the gearshift and/or the control unit, as a function of various influencing factors. The shift direction can in particular be taken into account, for example. With derailleur gears, changing from a smaller pinion to a larger one usually takes more time than changing from a larger pinion to a smaller one. Further, the current gear as well as the target gear may also be considered. In other words, the duration of the shift operation may depend on which gears are shifted during a gearshift.

Information such as the shift direction, the target gear and/or the current gear may in particular also be included in the shift information.

In particular, for example for a given pinion as well as a given shift direction, a number of revolutions of the pinion gear or the pinion cassette can be predetermined, which is the maximum required until the chain has safely changed the pinion and the shift operation is completed. A time period can then be derived from a current speed of the pinion gear or the pinion cassette, which, for example, is detectable upon knowledge of the pinion diameter via a speed sensor, in which the gear change will definitively be completed. From this time period, the end time can be determined in connection with the start time, in particular in a conservative manner.

In particular, it can be provided that the start of the reduction phase is selected as a function of the time at which the reduction of the drive torque is to or must be completed. This time preferably identifies the end of the reduction phase or the start of the lower holding phase. If this time is known, the required time at which the reduction of the drive torque must be started can be determined, in particular using the reduction gradient used.

The time at which the reduction of the drive torque must be completed, i.e. the end time of the reduction phase or the start of the lower holding phase, can be, for example, the start time encompassed by the shift information. However, it may be particularly preferable for this point in time to be later than the start point in time. Particularly with derailleur gears, the chain moves with a time delay relative to the shifter during a gear change. While the chain is not yet moving, torque can be transmitted therethrough without any mechanical damage being expected. Thus, until the chain is moved from pinion to pinion, the drive torque may be maintained to best assist the rider.

In order to determine or approximate the timing of the movement of the chain, for example, for a given pinion and a given shift direction, a number of revolutions of the pinion gear or the pinion cassette can be predetermined, which is at least required until the chain moves from pinion to pinion. From a current rotation speed of the pinion gear or the pinion cassette, which can be detected, e.g. via a speed sensor on the pinion cassette, in particular on a rear wheel of the pedal-driven vehicle, a time period can then be derived in which the chain certainly does not yet move from the start time point and thus no reduction of the drive torque is required. Alternatively, a rotation speed of a pinion, particularly on the rear wheel, may also be determined from a rotation speed of a crank mechanism of the pedal-driven vehicle, knowing the current transmission ratio. The end time of the reduction phase and the start of the lower holding phase, respectively, can thus be determined from this period in connection with the start time. The minimum time available until the chain moves may preferably be provided by the gearshift, in particular at the control unit.

In particular, the start of the reduction phase may be selected such that the first upper holding phase is maintained as long as possible. This results in the advantage that a driver can be assisted as long as possible by the drive.

The end of the lower holding phase or the start of the increase phase can preferably be characterized by the end time comprised by the shift information.

It may be advantageously provided with respect to the present disclosure that adjusting the target torque curve comprises:
transitioning from the first upper holding phase to the second upper holding phase when the completion time is within the first upper holding phase.

In other words, it may be provided that when the completion time is within the first upper holding phase, the system transitions directly from the first upper holding phase to the second upper holding phase. The transition between the first and the second upper holding phases can in particular be characterized in that the drive torque is kept constant. In particular, this can also ensure that no reduction of the drive torque occurs and that the rider is continuously assisted in the event of a termination of the planned shift operation.

Additionally or alternatively, it is contemplated that adjusting the target torque curve comprises:
increasing the drive torque and transitioning to the second upper holding phase when the completion time is within the reduction phase.

In other words, it may be provided that, if the completion time is within the reduction phase, the drive torque is increased again, in particular immediately, and subsequently the system transitions to the second upper holding phase. In particular, the drive torque can be increased by the amount by which it was previously reduced, starting from the first upper holding phase. This can ensure, in particular also in the event of a termination of the planned shift operation, that the reduced drive torque is increased as quickly as possible and that the rider thus receives the desired assistance from the drive again as quickly as possible.

Furthermore, it may be advantageously provided that adjusting the target torque curve comprises:
transitioning to the increase phase when the completion time is within the lower holding phase.

In other words, it can be provided that if the completion time is within the lower holding phase, the transition to the increase phase takes place immediately. The increase phase is thus brought forward in time compared to the originally determined target torque curve, which means that the rider's assistance from the drive is restored more quickly to the desired extent.

Additionally or alternatively, it may be provided that the reduction of the drive torque is linear in the reduction phase and/or that the increase of the drive torque is linear in the increase phase. This has proven particularly advantageous for a driver in terms of the comfort of use of the pedal-driven vehicle.

It may further be provided in relation to the disclosure that the method comprises:
detecting a speed signal of the drive, in particular by the detection unit, and determining the completion time as a function of the speed signal.

The speed signal is to be understood as a curve of the speed over time. The speed signal can in particular be detected or formed by the time-discrete detection of speed values. Based on the speed signal, the completion of a shift operation may be reliably detected.

According to a second aspect, the present disclosure relates to a pedal-driven vehicle, comprising at least one drive for providing drive torque for propelling the pedal-driven vehicle, at least one control unit, at least one detection unit, and at least one gearshift. The pedal-driven vehicle is preferably configured to be operated according to a method according to the disclosure. Preferably, the pedal-driven vehicle may be configured as a bicycle, preferably an electric cycle or pedelec. With respect to a pedal-driven vehicle, the same advantages result as described in relation to a method according to the disclosure. Preferably, the pedal-driven vehicle may comprise two wheels, in particular a front wheel and a rear wheel.

In particular, the gear shift may be provided to provide a variable transmission ratio, in particular in a drive train of the pedal-driven vehicle. The transmission ratio may be in particular characteristic of the number of revolutions of a drive wheel of the pedal-driven vehicle per revolution of a crank train of the vehicle. In this respect, a high transmission ratio or high gear characterizes a comparatively high number of revolutions of the drive gear per revolution of the crank train. In contrast, a low transmission ratio or low gear characterizes a comparatively low number of revolutions of the drive gear per revolution of the crank train. In particular, a driver of the pedal-driven vehicle may introduce a driver torque to propel the vehicle, in particular via crank-drive pedals, via the crank train.

In particular, a rear wheel of the pedal-driven vehicle may serve as a drive wheel that is drivable via a crank train. An effective connection between the drive wheel and the crank train may be formed via the gear shift, wherein the gear shift can provide a variable transmission ratio between the drive wheel and the crank mechanism.

In the present case, the gear shift may be configured as a derailleur gear system or a hub gear. In particular, the present disclosure has proven to be extremely advantageous with respect to a derailleur gear system.

Additionally or alternatively, it may be provided that the gear shift is configured as an automatic or at least partially automated gear shift. In particular, it can be provided that shift operations of the gear shift do not have to be triggered manually by a driver of the vehicle, but instead occur automatically based on one or more travel parameters. A travel parameter may be, for example, a speed of the pedal-driven vehicle, a pedaling frequency of a driver of the pedal-driven vehicle, a driver torque introduced by a driver of the pedal-driven vehicle to propel the vehicle, or a power provided by a driver of the pedal-driven vehicle to propel the vehicle.

It may be provided in the context of the disclosure that at least one detection unit comprises at least one sensor. In particular, the detection unit may comprise, for example, at least one speed sensor for detecting a speed of the drive. By an evaluation of the speed signal of the drive, in particular the completion of a shift operation can be concluded. In particular with derailleur gears, the short-term free-wheeling or the change of the pinion in the course of the shift operation results in fluctuations in the speed curve, which can be detected as such. Thus, the end time can be determined by an evaluation of the speed signal or the speed.

It may be provided in the context of the disclosure that at least one gearshift and/or control unit and/or detection unit and/or at least one drive comprises a data processing device. The data processing device may comprise at least one processor and/or working memory and/or non-volatile data store.

At least one control unit may be brought into communication and/or signal communication with a gear shift and/or detection unit and/or at least one drive, at least temporarily. Thus, data and/or control or regulating signals between the respective units may be exchanged.

According to a third aspect, the present disclosure relates to a computer program product comprising instructions that cause a pedal-driven vehicle according to the disclosure to perform a method according to the disclosure. With respect to a computer program product according to the disclosure, the same advantages result in that they have already been described in relation to a method according to the disclosure and/or a pedal-driven vehicle according to the disclosure.

According to a fourth aspect, the present disclosure relates to a computer-readable medium, in particular a storage medium, wherein a computer program product according to the disclosure is stored on the computer-readable medium. With respect to a computer-readable medium according to the disclosure, the same advantages result in that they have already been described in relation to a method according to the disclosure and/or a pedal-driven vehicle according to the disclosure and/or a computer program product according to the disclosure.

According to a fifth aspect, the present disclosure relates to a data carrier signal transmitting a computer program product according to the present disclosure. With respect to a data carrier signal according to the disclosure, the same advantages result in that they have already been described in relation to a method according to the disclosure and/or a pedal-driven vehicle according to the disclosure and/or a computer program product according to the disclosure and/or a computer-readable medium according to the disclosure.

### BRIEF DESCRIPTION OF THE DRAWINGS

Further advantages, features, and details of the disclosure emerge from the following description, in which exemplary embodiments of the disclosure are described in detail with reference to the drawings. The features mentioned in the claims and in the description can each be essential to the disclosure individually or in any combination.

The figures schematically show the following:

FIG. 1 is a schematic view of a method,

FIG. 2 is a schematic view of a pedal-driven vehicle, and

FIG. 3 is a schematic view of a target torque curve.

### DETAILED DESCRIPTION

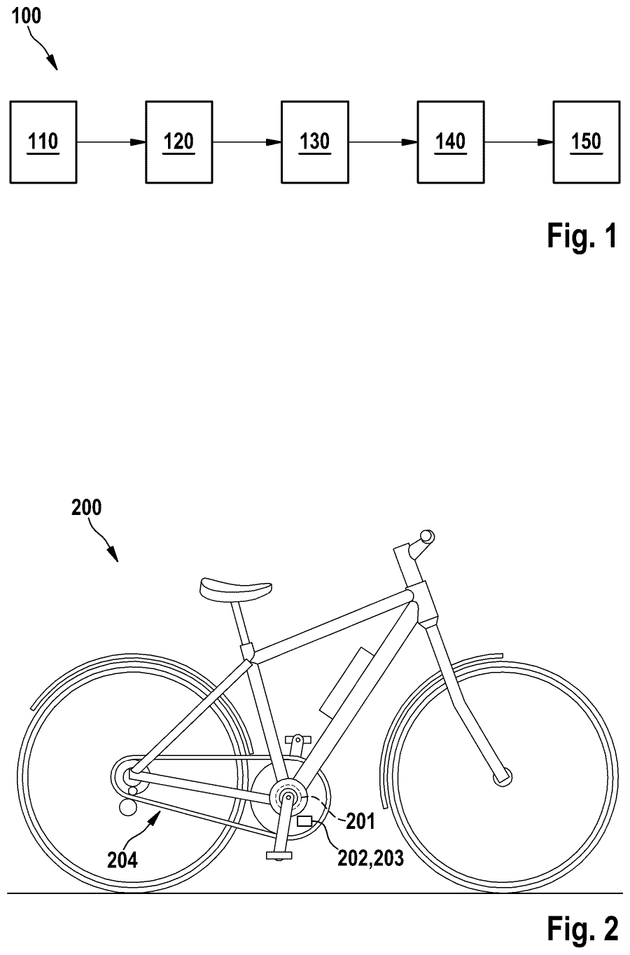

FIG. 1 illustrates a schematic view of a method for operating a pedal-driven vehicle 200, comprising a drive 201 for providing a drive torque AM for propelling the vehicle 200, a control unit 202, a detection unit 203 and a gear shift 204, the method 100 comprising:
providing 110 shift information for a planned shift operation, the shift information comprising a start time t_{Start} of the shift operation and an end time t_{End} of the planned shift operation,
determining 120 a target torque curve M_{Target} for the drive torque as a function of the shift information, wherein the target torque curve comprises a first upper holding phase 10, a reduction phase 20, a lower holding phase 30, an increase phase 40 and a second upper holding phase 50,
controlling 130 the drive such that the time curve of the drive torque corresponds to or substantially corresponds to the target torque curve,
performing 140 the planned shift operation and detecting a completion of the shift operation at a completion time t_{Done}, wherein the completion time t_{Done} is before the end time point (t_{End}), and
adjusting 150 the target torque curve M_{Target} as a function of the completion time t_{Done}.

FIG. 2 further illustrates a schematic view a pedal-driven vehicle 200, comprising a drive 201 for providing a drive torque AM for propelling the vehicle 200, at least one control unit 202, a detection unit 203 and a gearshift 204. Preferably, the pedal-driven vehicle 200 is configured to operate according to a method 100 shown in FIG. 1.

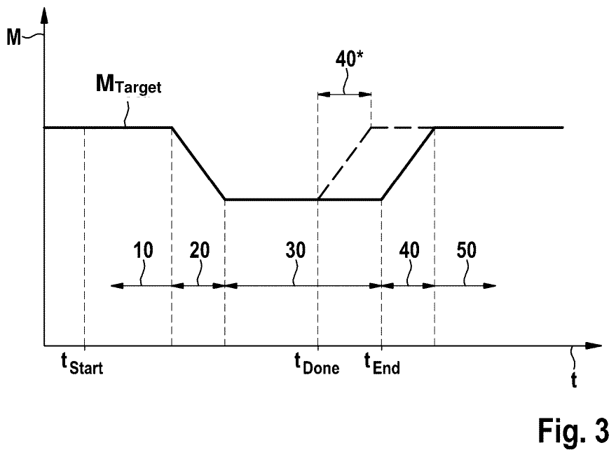

FIG. 3 further shows a schematic view of a target torque curve M_{Target}, comprising a first upper holding phase 10, a reduction phase 20, a lower holding phase 30, an increase phase 40 and a second upper holding phase 50. Preferably, the end time of the reduction phase 20 or the start of the lower holding phase 30 is after the start time t_{Start} in order to maintain the drive torque M as long as possible.

Furthermore, the end time of the lower holding phase 30 or the start of the increase phase 40 is characterized by the end time t_{End}.

The dashed line further outlines an exemplary adjustment of the target torque curve M_{Target} as a function of the completion time t_{Done}. As can be seen from FIG. 3, the completion of the shift operation, which is characterized by the completion time point t_{Done}, is within the lower holding phase 30 and before the originally forecasted end time point t_{End}. For this reason, before reaching the end time t_{End} and immediately after completion of the shift operation, the transition is to the now advanced increase phase 40.

The above explanation of the embodiments describes the present disclosure solely within the scope of examples. Of course, individual features of the embodiments can be freely combined with one another, if technically feasible, without leaving the scope of the present disclosure.

What is claimed is:

1. A method for operating a pedal-driven vehicle that includes a drive for providing a drive torque for propelling the vehicle, a control unit, a detection unit, and a gearshift, the method comprising:
providing shift information for a planned shift operation, the shift information comprising a start time of the planned shift operation and an end time of the planned shift operation;
determining a target torque curve for the drive torque as a function of the shift information, wherein the target torque curve comprises a first upper holding phase, a reduction phase, a lower holding phase, an increase phase, and a second upper holding phase;
controlling the drive such that the time curve of the drive torque corresponds to or substantially corresponds to the target torque curve;
performing the planned shift operation and detecting a completion of the planned shift operation at a completion time, wherein the completion time is before the end time point, and
adjusting the target torque curve as a function of the completion time.

2. The method according to claim 1, wherein the adjusting step comprises:
transitioning from the first upper holding phase to the second upper holding phase when the completion time is within the first upper holding phase.

3. The method according to claim 1, wherein the adjusting step comprises:
increasing the drive torque and transitioning to the second upper holding phase when the completion time is within the reduction phase.

4. The method according to claim 1, wherein the adjusting step comprises:
transitioning to the increase phase when the completion time is within the lower holding phase.

5. The method according to claim 1, wherein:
the reduction of the drive torque in the reduction phase is linear and/or the increase of the drive torque in the increase phase is linear.

6. The method according to claim 1, wherein:
the start of the reduction phase is selected such that the first upper holding phase is maintained as long as possible.

7. The method according to claim 1, further comprising:
detecting a speed signal of the drive by the detection unit; and
determining the completion time as a function of the speed signal.

8. A pedal-driven vehicle, comprising:
at least one drive configured to provide a drive torque for propelling the vehicle;
at least one control unit;
a detection unit; and
a gearshift,
wherein the pedal-driven vehicle is configured to be operated according to the method of claim 1.

9. A computer program product comprising instructions that cause a pedal-driven vehicle to perform the method according to claim 1.

10. A computer-readable medium on which the computer program product according to claim 9 is stored.

11. A data carrier signal transmitting the computer program product according to claim 9.
